(19) United States
(12) Patent Application Publication
(10) Pub. No.: US 2023/0264501 A1
(43) Pub. Date: Aug. 24, 2023

(54) LIQUID EJECTING APPARATUS

(71) Applicant: SEIKO EPSON CORPORATION, Tokyo (JP)

(72) Inventors: Masaki Tsukida, Shiojiri (JP); Toru Matsuyama, Matsumoto (JP)

(21) Appl. No.: 18/172,401

(22) Filed: Feb. 22, 2023

(30) Foreign Application Priority Data
Feb. 24, 2022 (JP) 2022-026896

(51) Int. Cl. B41J 29/38

(52) U.S. Cl. CPC B41J 29/38

(57) ABSTRACT

A liquid ejecting apparatus includes: a housing; an ejector arranged in the housing and configured to eject a liquid; a power supply circuit arranged in the housing and configured to supply power to the ejector; and a partition arranged so as to separate an ejector region where the ejector is arranged and a power supply circuit region where the power supply circuit is arranged, in which the power supply circuit includes a capacitor and a transformer, no fan is arranged in the power supply circuit region, and the liquid contains a polysaccharide.

The present application is based on, and claims priority from JP Application Serial Number 2022-026896, filed Feb. 24, 2022, the disclosure of which is hereby incorporated by reference herein in its entirety.

### BACKGROUND

### 1. Technical Field

The present disclosure relates to a liquid ejecting apparatus.

### 2. Related Art

DTG (Direct to Garment) printers that perform printing on fabrics such as clothing using an ink jet method have been developed. There have also been considerations made to increase the speed and size of the DTG printer so that the printer can directly perform printing on T-shirts and the like, for example. However, when the speed and size of the printer are increased, the power consumption of a power supply circuit provided in a housing of the printer increases, and heat generated by electric circuits cannot be ignored.

For example, JP-A-2000-211163 discloses a printer that cools electric circuits such as a power supply circuit provided in a housing of the printer. The printer has a mechanism for dissipating heat generated by the power supply circuit to the outside of the housing using a fan.

The DTG printer is required to sufficiently fix ink to be used on a medium such as a fabric. Therefore, studies have also been made to improve the fixability of the ink. For example, it has been proposed to apply a pretreatment liquid to the medium before applying the ink to the medium, thereby improving the fixability of the ink. Such a pretreatment liquid may contain a polysaccharide thickening component such as hydroxyethyl cellulose or guar gum.

When such a pretreatment liquid is ejected by the DTG printer, the pretreatment liquid may become mist inside the housing of the DTG printer. When the DTG printer is provided with a fan, air generated inside the housing by the fan carries the mist of the pretreatment liquid, which may adhere to various parts of the housing. The solvent component of the pretreatment liquid evaporates and the thickening component solidifies and remains at the adhered parts. When the thickening component solidifies in a part where the fan rotates, for example, the rotation of the fan is hindered, resulting in more frequent printer maintenance and reduced productivity.

Therefore, there is a demand for a liquid ejecting apparatus capable of maintaining high productivity even when using a pretreatment liquid containing a polysaccharide.

### SUMMARY

A liquid ejecting apparatus according to an aspect of the present disclosure includes: a housing; an ejector arranged in the housing and configured to eject a liquid; a power supply circuit arranged in the housing and configured to supply power to the ejector; and a partition arranged so as to separate an ejector region where the ejector is arranged and a power supply circuit region where the power supply circuit is arranged, in which the power supply circuit includes a capacitor and a transformer, no fan is arranged in the power supply circuit region, and the liquid contains a polysaccharide.

### BRIEF DESCRIPTION OF THE DRAWINGS

FIG. 1 is a perspective view showing an outline of a liquid ejecting apparatus 1.

FIG. 2 is a diagram showing a functional configuration of the liquid ejecting apparatus 1.

FIG. 3 is a diagram showing an example of a signal generated by a drive circuit.

FIG. 4 is a schematic diagram showing an example of arrangement of components inside the housing of the liquid ejecting apparatus.

FIG. 5 is a schematic plan view showing an example of a power supply unit including a power supply circuit.

FIG. 6 is a schematic side view showing an example of the power supply unit including the power supply circuit.

### DESCRIPTION OF EXEMPLARY EMBODIMENTS

Embodiments of the present disclosure are described below. The embodiments described below illustrate examples of the present disclosure. The present disclosure is by no means limited to the following embodiments, and includes various modifications implemented within the scope of the present disclosure. Note that not all of the configurations described below are essential configurations of the present disclosure.

A liquid ejecting apparatus according to this embodiment includes: a housing; an ejector arranged in the housing and configured to eject a liquid; a power supply circuit arranged in the housing and configured to supply power to the ejector; and a partition arranged so as to separate an ejector region in which the ejector is arranged and a power supply circuit region in which the power supply circuit is arranged. The liquid ejecting apparatus is described below with reference to the drawings.

1. Summary of Liquid Ejecting Apparatus

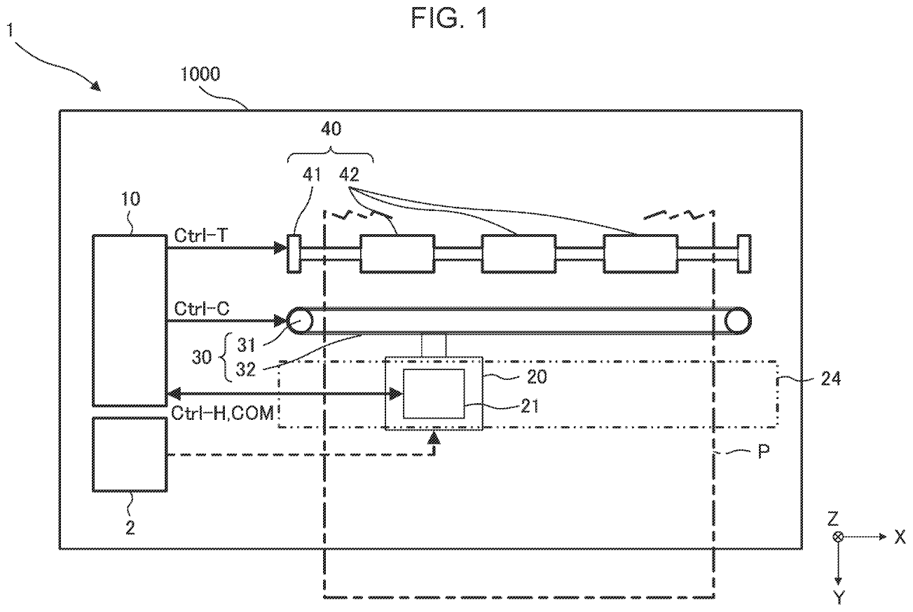

FIG. 1 is a diagram showing a schematic configuration of a liquid ejecting apparatus 1. The liquid ejecting apparatus 1 according to this embodiment is a serial-printing ink jet printer in which a carriage 20 equipped with a liquid ejecting head 21 that ejects ink as an example of a liquid reciprocates and ejects the ink onto a medium P to be transported, thereby forming an image on the medium P.

The following description is given assuming that a direction in which the carriage 20 moves is an X direction, a direction in which the medium P is transported is a Y direction, and a direction in which the ink is ejected is a Z direction. Although the X, Y and Z directions are described as directions orthogonal to each other, the various components included in the liquid ejecting apparatus 1 are not limited to being orthogonal to each other.

As the medium P, any print target such as printing paper, resin film, and fabric can be used. Note that the liquid ejecting apparatus 1 may have a configuration in which the liquid ejecting heads 21 are arranged side by side so that nozzle arrays are formed to be wider than the width of the medium P. The liquid ejecting apparatus 1 may also be a so-called line-printing ink jet printer that forms a desired image on the medium P by ejecting the ink from the liquid ejecting head 21 onto the medium P to be transported.

As shown in FIG. 1, the liquid ejecting apparatus 1 includes a housing 1000, a control mechanism 10, a carriage 20, a liquid ejecting head 21, a moving mechanism 30, and a transport mechanism 40.

The control mechanism 10 includes electric circuits such as a drive circuit 50 and a power supply circuit 55. These electric circuits may include, for example, processing circuits such as a central processing unit (CPU) and a field programmable gate array (FPGA), memory circuits such as a semiconductor memory, the power supply circuit 55 that is coupled to a commercial AC power source and converts power supplied from the commercial AC power source into appropriate power and supply the power to each part, a drive signal output circuit 51 that drives the liquid ejecting head 21, and the like. The control mechanism 10 controls each of the components of the liquid ejecting apparatus 1 including the liquid ejecting head 21.

The carriage 20 has the liquid ejecting head 21 mounted thereon. The carriage 20 is also fixed to an endless belt 32 included in the moving mechanism 30. Ink containers such as ink tanks and ink cartridges may be mounted on the carriage 20. Alternatively, ink may be supplied to the liquid ejecting head 21 through a tube or the like from an ink tank or the like installed in a location other than the carriage 20.

A control signal Ctrl-H outputted from the control mechanism 10 to control the liquid ejecting head 21 and one or more drive signals COM to drive the liquid ejecting head 21 are inputted to the liquid ejecting head 21. Then, the liquid ejecting head 21 ejects the ink supplied from the ink container based on the inputted control signal Ctrl-H and drive signal COM.

The liquid ejecting head 21 corresponds to an ejector that is arranged inside the housing 1000 and ejects a liquid. The ejector is arranged in an ejector region 24 inside the housing 1000. The ejector region 24 is a region within which the liquid ejecting head 21 moves as the carriage 20 moves.

The moving mechanism 30 includes a carriage motor 31 and the endless belt 32. The carriage motor 31 operates based on a control signal Ctrl-C inputted from the control mechanism 10. The endless belt 32 rotates according to the operation of the carriage motor 31. Thus, the carriage 20 fixed to the endless belt 32 reciprocates in the X direction.

The transport mechanism 40 includes a transport motor 41 and transport rollers 42. The transport motor 41 operates based on a control signal Ctrl-T inputted from the control mechanism 10. The transport rollers 42 rotate according to the operation of the transport motor 41. The medium P is transported in the Y direction as the transport roller 42 rotates.

As described above, in the liquid ejecting apparatus 1, the liquid ejecting head 21 mounted on the carriage 20 ejects the ink in the Z direction in conjunction with the transport of the medium P by the transport mechanism 40 and the reciprocation of the carriage 20 by the moving mechanism 30, and the ink lands on arbitrary positions on the surface of the medium P. Thus, a desired image can be formed on the medium P.

2. Functional Configuration of Liquid Ejecting Apparatus

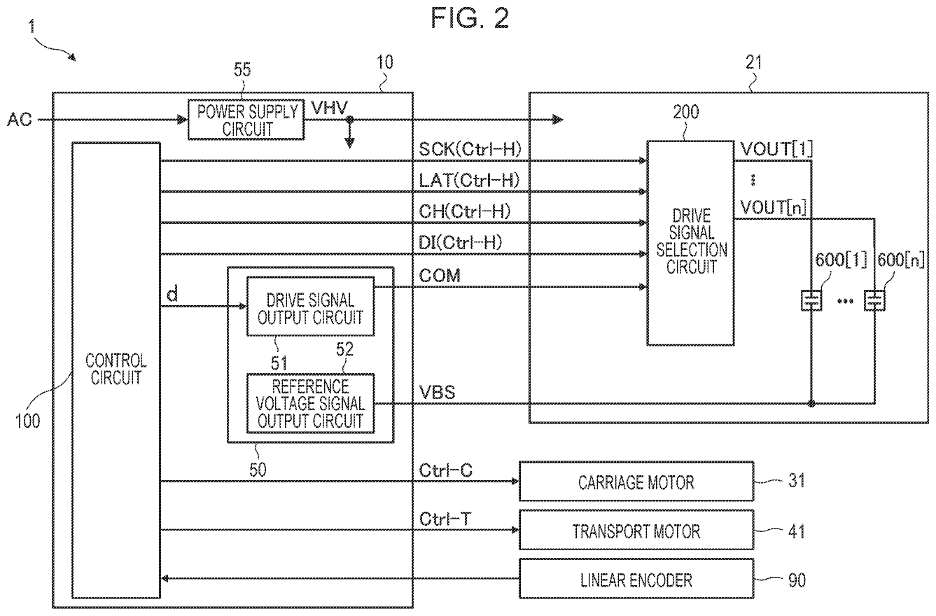

Next, a functional configuration of the liquid ejecting apparatus 1 is described. FIG. 2 is a diagram showing the functional configuration of the liquid ejecting apparatus 1. As shown in FIG. 2, the liquid ejecting apparatus 1 includes the control mechanism 10, the liquid ejecting head 21, the carriage motor 31, the transport motor 41, and a linear encoder 90.

The control mechanism 10 includes the drive circuit 50, the power supply circuit 55, and a control circuit 100. The control circuit 100 includes a processor such as a microcontroller, for example. Based on various signals such as image data inputted from a host computer or the like communicably coupled to the outside, the control circuit 100 generates various data to control the liquid ejecting apparatus 1 and signals based on the data and outputs such data and signals to the corresponding configuration.

A specific example of the operation of the control circuit 100 is described. The control circuit 100 identifies a scanning position of the liquid ejecting head 21 mounted on the carriage 20 based on a detection signal inputted from the linear encoder 90. The control circuit 100 generates and outputs various signals according to the scanning position of the liquid ejecting head 21. To be more specific, the control circuit 100 generates the control signal Ctrl-C to control the reciprocation of the liquid ejecting head 21 and outputs the generated control signal to the carriage motor 31. The control circuit 100 also generates the control signal Ctrl-T to control the transport of the medium P and outputs the generated control signal to the transport motor 41. The control signal Ctrl-C may be inputted to the carriage motor 31 after signal conversion via a driver circuit (not shown). Likewise, the control signal Ctrl-T may be inputted to the transport motor 41 after signal conversion via the driver circuit (not shown).

Further, the control circuit 100 generates a head control signal DI, a change signal CH, a latch signal LAT, and a clock signal SCK as the control signals Ctrl-H to control the liquid ejecting head 21 based on various signals such as image data inputted from the host computer and the scanning position of the liquid ejecting head 21, and outputs those signals to the liquid ejecting head 21.

The control circuit 100 also outputs a base drive signal d, which is a digital signal, to the drive circuit 50.

The drive circuit 50 includes the drive signal output circuit 51 and a reference voltage signal output circuit 52. The base drive signal d is inputted to the drive signal output circuit 51. The drive signal output circuit 51 performs digital/analog signal conversion on each base drive signal d and then performs class D amplification of the converted analog signal to generate and output a drive signal COM as a drive signal. That is, the base drive signal d is a digital signal that defines the waveform of the drive signal COM.

Then, the drive signal output circuit 51 generates and outputs the drive signal COM by performing the class D amplification of the waveform defined by the base drive signal d. That is, the drive signal output circuit 51 includes a class D amplifier circuit. Note that the base drive signal d may be any signal that can define the waveform of the drive signal COM, and may be an analog signal, for example. Further, the drive signal output circuit 51 only needs to be able to amplify the waveform defined by the base drive signal d, and may include a class A amplifier circuit, a class B amplifier circuit, a class AB amplifier circuit or the like, for example.

The reference voltage signal output circuit 52 outputs a reference voltage signal VBS indicating a reference potential of the drive signal COM. The reference voltage signal VBS may be, for example, a ground potential signal with a voltage value of 0 V, or a DC voltage signal with a voltage value of 5.5 V, 6 V, or the like.

The drive signal COM and the reference voltage signal VBS outputted by the drive circuit 50 are outputted to the liquid ejecting head 21.

The liquid ejecting head 21 includes a drive signal selection circuit 200 and ejectors 600[1] to 600[n]. For example, n is a value such as 400, 800 or 1600. Note that the ejectors 600[1] to 600[n] all have the same configuration, and may be simply referred to as the ejector 600 when there is no need to distinguish therebetween.

The drive signal selection circuit 200 is configured as an integrated circuit device, for example. The clock signal SCK, latch signal LAT, change signal CH, head control signal DI, and drive signal COM are inputted to the drive signal selection circuit 200. Then, the drive signal selection circuit 200 generates VOUT[1] to VOUT[n] by selecting or deselecting the drive signal COM based on the clock signal SCK, latch signal LAT, change signal CH, and head control signal DI inputted, and then outputs the generated VOUT[1] to VOUT[n] to the corresponding ejectors 600[1] to 600[n], respectively. The VOUT[1] to VOUT[n] may be simply referred to as VOUT when there is no need to distinguish therebetween.

The power supply circuit 55 is a flyback switching power supply circuit, for example. A voltage AC that is an AC power supply voltage is supplied to the power supply circuit 55, and the power supply circuit 55 generates and outputs a voltage VHV that is a DC voltage from the supplied voltage AC. The voltage VHV generated by the power supply circuit 55 is supplied to each part of the liquid ejecting apparatus 1 including the liquid ejecting head 21 and the drive circuit 50, so that each part of the liquid ejecting apparatus 1 performs desired operations.

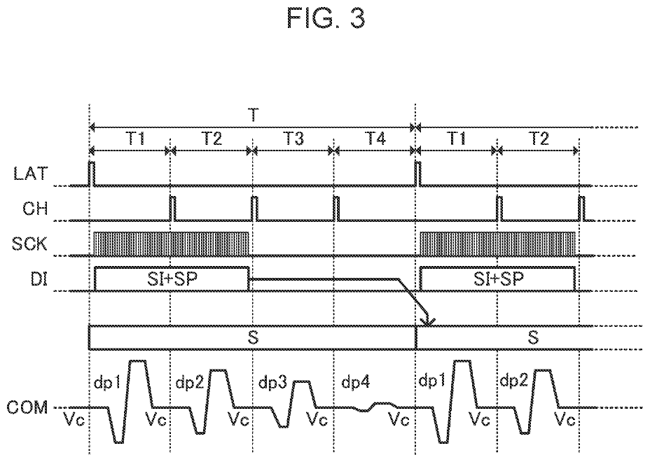

Here, the latch signal LAT, change signal CH, clock signal SCK, head control signal DI, and drive signal COM inputted to a selection control circuit 210 from the control mechanism 10 are described with reference to FIG. 3. FIG. 3 is a diagram for explaining the latch signal LAT, change signal CH, clock signal SCK, head control signal DI, and drive signal COM.

The latch signal LAT is a pulse signal outputted by the control circuit 100 based on a signal outputted by the linear encoder 90 to indicate the scanning position of the carriage 20 having the liquid ejecting head 21 mounted thereon. The liquid ejecting head 21 ejects liquid droplets to form dots on the medium P between pulses of the latch signal LAT. That is, the liquid ejecting head 21 ejects the ink to form dots on the medium P.

Thus, the liquid ejecting head 21 can eject a predetermined amount of ink at a desired position on the medium P along a main scanning direction, and thus can form dots of a desired size at desired positions on the medium P. A period between a rise of the latch signal LAT and a rise of the next latch signal corresponds to a print cycle, and corresponds to a dot formation cycle T for forming dots on the medium P. More specifically, the latch signal LAT is a signal that indicates the scanning position of the liquid ejecting head 21 with respect to the medium P, and is also a signal that defines the dot formation cycle T for forming dots on the medium P according to the scanning position of the liquid ejecting head 21.

The change signal CH is a pulse signal that defines switching timing to switch whether or not the drive signal selection circuit 200 supplies the drive signal COM as VOUT to the ejector 600. The control circuit 100 outputs the change signal CH to divide the dot formation cycle T into a plurality of periods. For example, the change signal CH is a pulse signal that is outputted three times in the dot formation cycle T. More specifically, the change signal CH defines the dot formation cycle T as four periods T1, T2, T3, and T4.

Then, the drive signal selection circuit 200 switches whether to supply the drive signal COM as VOUT to the ejector 600 in the period Tl, and switches whether to supply the drive signal COM as VOUT to the ejector 600 in the period T2. Likewise, the drive signal selection circuit 200 switches whether to supply the drive signal COM as VOUT to the ejector 600 in the period T3, and switches whether to supply the drive signal COM as VOUT to the ejector 600 in the period T4. As a result, the ink ejected in the period T1, the ink ejected in the period T2, the ink ejected in the period T3, and the ink ejected in the period T4 during the dot formation cycle T are combined to form one dot on the medium P.

As described above, the drive signal selection circuit 200 uses the change signal CH to define the dot formation cycle T as the periods T1 to T4, and switches whether to supply the drive signal COM as VOUT to the ejector 600 in each of the periods T1 to T4. Thus, the liquid ejecting head 21 can form dots of a plurality of sizes on the medium P. As a result, multi-gradation dots can be formed on the medium P, and a high-definition image can be formed on the medium P. That is, the change signal CH defines the switching timing of the drive signal selection circuit 200.

The head control signal DI is a signal synchronized with the clock signal SCK, and serially includes an ejection control signal SI that individually defines the amount of ink ejected to the medium P by nozzles 651 of the n ejectors 600, respectively, and a setting information signal SP to define a relationship between the ejection control signal SI and a logic level of a selection signal S outputted in each of the periods T1 to T4 defined by the change signal CH.

The head control signal DI is supplied to the selection control circuit 210 in the dot formation cycle T before the latch signal LAT rises in synchronization with the clock signal SCK, and is held in a register of the selection control circuit 210 in a state of corresponding to the n ejectors 600. The head control signals DI held in the register are latched all at once as the latch signal LAT rises, thereby defining the logic level of the selection signal S in the dot formation cycle T defined including the latch signal LAT.

The drive signal COM includes at least one drive waveform, which is described here as a drive waveform. The drive waveform includes a waveform obtained by combining a drive waveform dp1 arranged in the period T1 between the rise of the latch signal LAT and the rise of a first change signal CH, a drive waveform dp2 arranged in the period T2 between the rise of the first change signal CH and the rise of a second change signal CH, a drive waveform dp3 arranged in the period T3 between the rise of the second change signal CH and the rise of a third change signal CH, and a drive waveform dp4 arranged in the period T4 between the rise of the third change signal CH and the rise of the latch signal LAT. Note that the drive waveforms dp1 to dp4 are an example of ejection pulses.

For example, the drive waveform dp3 is a waveform for ejecting a small amount of ink from the nozzles, and the drive waveform dp2 is a waveform for ejecting a medium amount of ink, which is larger than the small amount, from the nozzles. The drive waveform dp1 is a waveform for ejecting a large amount of ink, which is larger than the medium amount, from the nozzles. Further, dp4 is a waveform for ejecting no ink from the nozzles, and is a waveform for preventing an increase in ink viscosity by vibrating the ink near nozzle orifices.

Here, as shown in FIG. 3, the voltages at the start timing and end timing are set to a common voltage Vc for all of the drive waveforms dp1 to dp4. That is, the drive waveforms dp1 to dp4 each start at the voltage Vc and end at the voltage Vc. The drive waveforms dp1 to dp4 are illustrated as different waveforms in FIG. 3, but may include a plurality of the same waveforms. More specifically, the waveform of the drive signal COM is not limited to those shown in FIG. 3, but various waveforms may be combined depending on the movement speed of the carriage 20 having the liquid ejecting head 21 mounted thereon, the properties of the ink supplied to the liquid ejecting head 21, and the material of the medium P.

3. Liquid

In this embodiment, the liquid ejected by the liquid ejecting head 21 contains a polysaccharide. Examples of the polysaccharide include cellulose, chitin, chitosan, starch, pullulan, carrageenan, agar, curdlan, furcellulan, xanthan gum, guar gum, gum Arabic, schizophyllan, hyaluronic acid, alginic acid, sodium alginate, pectin, welan gum, and these and derivatives thereof.

Specific examples of cellulose derivatives, which are derivatives of cellulose alone, include methylcellulose, hydroxyethylcellulose, hydroxypropylcellulose, hydroxypropylmethylcellulose, carboxymethylcellulose, acetylcellulose, nitrocellulose, carboxymethylnitrocellulose and the like. The cellulose derivatives also include crystalline celluloses.

The polysaccharide content in the liquid is not particularly limited, but is, for example, equal to or more than 0.1% by mass and equal to or less than 30% by mass, preferably equal to or more than 0.2% by mass and equal to or less than 20% by mass, more preferably equal to or more than 0.5% by mass and equal to or less than 10% by mass.

The polysaccharide contained in the liquid functions as a thickener. The liquid may contain water, an organic solvent, a flocculant, a color material, a surfactant, and the like, in addition to the polysaccharide. These substances are contained in the liquid as appropriate depending on the purpose. Particularly, examples of flocculants include organic acids, polyvalent metal salts of organic acids, cationic polymers, inorganic acids, metal salts of inorganic acids, and the like. When the liquid contains a flocculant, the liquid is suitably used as a pretreatment liquid for fabrics in textile printing. The use of such a liquid can improve the color development of a printed material, for example.

Furthermore, any additives may be added to the liquid. Examples of such additives include a dispersant, surfactant, preservative, antifungal agent, flocculant, antifoaming agent, leveling agent, wetting agent, antioxidant, ultraviolet absorber, pH adjuster, and the like.

4. Arrangement of Components in Housing

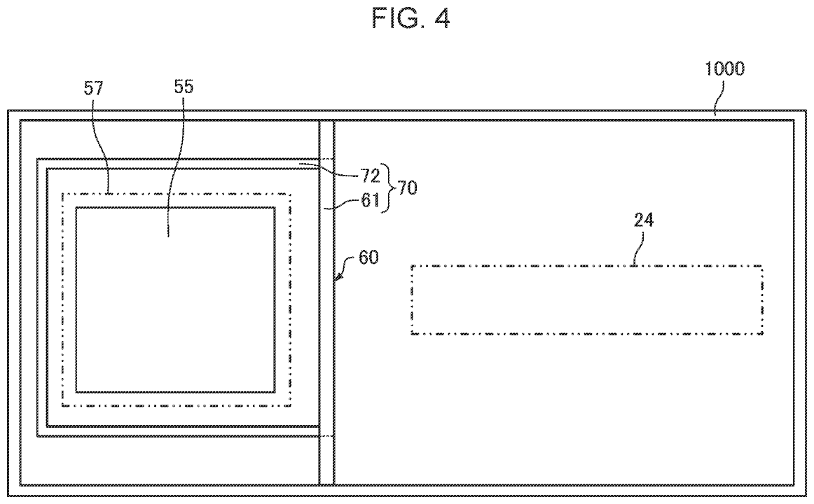

FIG. 4 is a schematic diagram showing an example of arrangement of the components in the housing 1000 of the liquid ejecting apparatus 1. The liquid ejecting apparatus 1 includes at least a power supply circuit region 57, the ejector region 24, and a partition 60 in the housing 1000. In the liquid ejecting apparatus 1, the power supply circuit 55 is arranged in the power supply circuit region 57. No fan is arranged in the power supply circuit region 57.

In the housing 1000, components other than the power supply circuit region 57, the ejector region 24, and the partition 60 may be arranged. Moreover, the partition 60 may be shared with a part of the other components in the housing 1000.

In the liquid ejecting apparatus 1, the power supply circuit region 57 is separated from other regions inside the housing 1000 by a power supply box 70 inside the housing 1000. A box forming section 61 of the partition 60 forms one surface of the power supply box 70. That is, the power supply box 70 includes the box forming section 61 of the partition 60 and a cover section 72 having an opening corresponding to the box forming section 61.

A part of the wall surface of the housing 1000 may form one surface of the power supply box 70. That is, the power supply box 70 may include the box forming section 61 of the partition 60, a part of the inner wall surface of the housing 1000, and the cover section 72 having openings corresponding thereto.

5. Power Supply Circuit

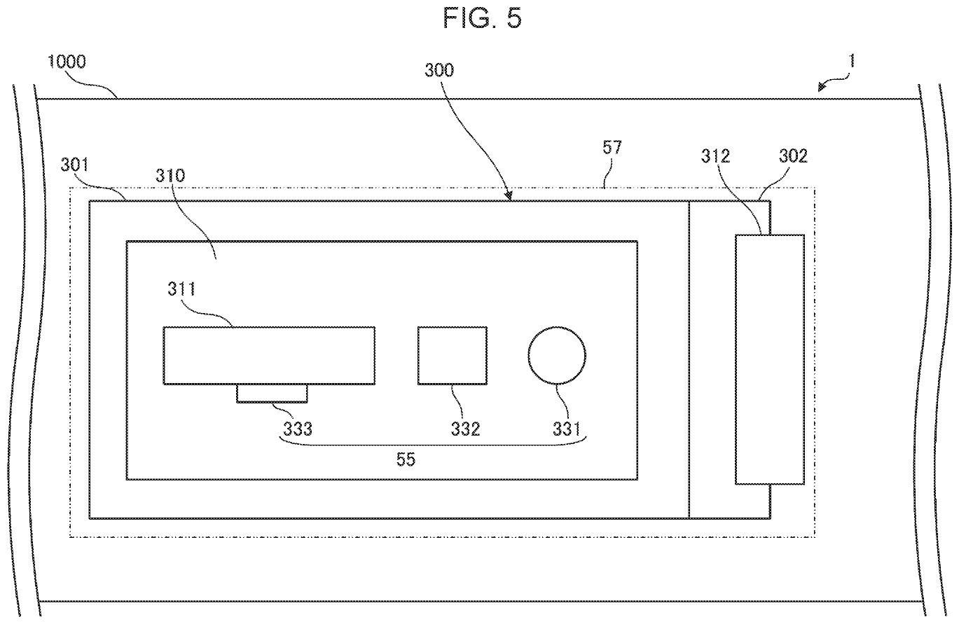

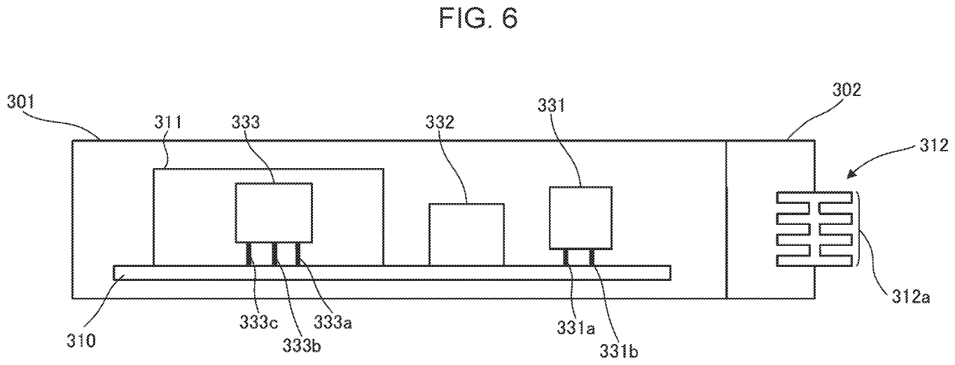

A power supply circuit includes a capacitor and a transformer. FIG. 5 is a schematic plan view showing a power supply unit 300 as an example of a power supply unit including the power supply circuit. FIG. 6 is a schematic side view showing the power supply unit 300 as an example of the power supply unit including the power supply circuit.

The power supply unit 300 is included in the control mechanism 10 and houses the power supply circuit 55 in the power supply circuit region 57. Likewise, the electric circuits such as the drive circuit 50 may be housed in separate cases separate from the liquid ejecting head 21.

The power supply unit 300 includes a first unit 301 and a second unit 302, and has a closed box structure as a whole. As for the closed structure of the power supply unit 300, minimum necessary holes such as a hole for drawing a cable into the power supply unit 300 and a ventilation hole are provided, for example, including a state where the unit is not completely closed. The second unit 302 may be integrated with or detachably attached to the first unit 301.

The first unit 301 includes a substrate 310 and a first heat sink 311. The substrate 310 may be, for example, a printed circuit board having conductor wiring on its surface. On the substrate 310, a capacitor 331, a transformer 332, a power transistor 333, and the first heat sink 311 are disposed. Note that wirings 333a, 333b, and 333c shown in FIG. 6 are coupled to a source, a gate, and a drain of the power transistor 333, for example. Wirings 331a and 331b shown in FIG. 6 are terminals of the capacitor 331, for example.

The capacitor 331, the transformer 332, and the power transistor 333 are components that make up the power supply circuit 55. The first heat sink 311 dissipates heat generated by the power supply circuit 55. In FIGS. 5 and 6, the first heat sink 311 is disposed on the substrate 310 so as to come in contact with the power transistor 333 with a large heat dissipation amount. The first heat sink 311 may be disposed so as to come into contact with any other component with a large heat dissipation amount, for example, without impairing the function of the power supply circuit 55. Thus, the heat dissipation effect of the power supply circuit 55 is enhanced.

The second unit 302 has a second heat sink 312. The heat dissipated from the first heat sink 311 in the first unit 301 is guided to the second heat sink 312 by radiation and/or heat conduction. Then, the second heat sink 312 that receives the heat generated in the first unit 301 is cooled by heat dissipation. More specifically, the heat dissipated from the first heat sink 311 is absorbed by the second heat sink 312 and dissipated through a heat dissipation fin 312a of the second heat sink 312. Thus, the heat generated by the power supply circuit 55 is dissipated to the outside of the power supply unit 300. In the example shown in FIG. 6, the heat dissipation fin 312a is provided inside the housing 1000. Alternatively, the heat generated by the power supply circuit 55 may be dissipated to the outside of the housing 1000 by changing the arrangement of the power supply unit 300, changing the shape of the heat dissipation fin 312a and/or providing a heat transfer path and providing the heat dissipation fin 312a outside the housing 1000.

Note that, in this embodiment, a fan that generates an airflow for heat dissipation is not provided in the power supply circuit region 57 accommodated in the power supply unit 300. However, in the liquid ejecting apparatus 1, a fan that generates an airflow for heat dissipation may be installed in a location other than the power supply circuit region 57 inside the housing 1000. However, since the airflow generated by the fan may diffuse mist to be described later, it is preferable that the fan is not disposed inside the housing 1000 of the liquid ejecting apparatus 1.

As described above, the power supply unit 300 includes the capacitor 331. Although any appropriate capacitor can be used as the capacitor 331, it is preferable that an electrolytic capacitor is used as the capacitor 331 in terms of capacity and characteristics. The shape of the electrolytic capacitor can be arbitrarily selected from a lead form, a substrate self-support form, a chip form, and the like.

There are many types of electrolytic capacitors, including a terminal lead-out structure, a sealing material, and a sealing structure. A typical electrolytic capacitor has a structure in which an element obtained by rolling an anode aluminum foil, an electrolytic paper, a cathode aluminum foil, and an electrode terminal is impregnated with an electrolytic solution and housed in an aluminum case, which is sealed with a sealing plate having a shape that allows the terminal to be drawn to the outside, the aluminum case having its lateral surface covered with a sleeve.

When the capacitor 331 is the electrolytic capacitor, it is preferable that the sleeve is made of polyolefin. Examples of polyolefin include polyethylene, polypropylene, ethylene-propylene copolymer, and the like.

Further, when the capacitor 331 is the electrolytic capacitor, it is preferable that the electrolytic solution is composed mainly of ethylene glycol and contains water. In such an electrolytic capacitor, an increase in the internal pressure of the capacitor is suppressed and its characteristics are less likely to deteriorate, making it possible to improve reliability.

Moreover, when the capacitor 331 is the electrolytic capacitor, it is preferable that the capacitor has an aluminum case. Such an electrolytic capacitor has characteristics less likely to deteriorate, making it possible to further improve the reliability of the apparatus.

Furthermore, when the capacitor 331 is the electrolytic capacitor, it is more preferable to select a sealing plate made of a material in which an EPT rubber layer and a bakelite layer are laminated. When such an electrolytic capacitor is used, the characteristics of the capacitor are less likely to deteriorate, making it possible to further improve the reliability of the apparatus.

Furthermore, when the capacitor 331 is the electrolytic capacitor, it is preferable that its terminals are plated with copper and tin. For example, it is preferable that the capacitor 331 shown in FIG. 6 is the electrolytic capacitor and one or both of the terminals 331a and 331b are plated with copper and tin. When such an electrolytic capacitor is used, the characteristics of the capacitor are good and the reliability of the apparatus can be further improved.

6. Mist and Advantageous Effect

The liquid described above may float as mist when ejected from the liquid ejecting head 21. This mist may be generated, for example, due to minute liquid droplets called satellites when the liquid is ejected and formed into liquid droplets. The mist floats inside the housing 1000 and may adhere to the inner wall of the housing 1000 and the constituent members inside the housing 1000. The mist adhering to an object loses volatile components in the liquid by drying, and the solid content in the liquid adheres to the object. In the liquid ejecting apparatus 1 of this embodiment, the liquid contains at least a polysaccharide. Therefore, when mist is generated, at least the polysaccharide adheres to the members inside the housing 1000.

Although the polysaccharide functions as a thickener in the liquid, the concentration of the polysaccharide in the liquid increases when the liquid loses its volatile component. Therefore, when mist is generated, high-viscosity substances gradually accumulate in the members inside the housing 1000.

For example, when a fan for heat dissipation is provided in the power supply circuit region 57, mist may adhere to a rotation mechanism of the fan and high-viscosity substances may accumulate and hinder the rotation of the fan. Such problems are more likely to occur when the liquid contains a polysaccharide.

However, as already described, the liquid ejecting apparatus 1 of this embodiment has no fan disposed in the power supply circuit region 57, and thus such problems can be prevented. When the liquid ejecting apparatus 1 has no fan inside the housing 1000, it is possible to prevent mist from hindering the rotation of the fan, and the like.

In the liquid ejecting apparatus 1 of this embodiment, since no fan is disposed in the power supply circuit region 57, the mist is less likely to be dispersed by the fan, making it possible to prevent problems such as short circuit of the electric circuit and electric leakage.

Since the liquid ejecting apparatus 1 of this embodiment has the partition 60 that separates the ejector region 24 and the power supply circuit region 57, floating mist is unlikely to reach the power supply circuit region 57. Thus, it is possible to prevent problems such as short circuit of the power supply circuit 55 and electric leakage.

When the liquid ejecting apparatus 1 is a textile printer, the printer is often large, and the amount of mist floating in the housing 1000 is greater than that of a normal printer for home use. Even when the liquid ejecting apparatus 1 is the textile printer, the above effects can be sufficiently obtained. More specifically, when the liquid ejecting apparatus 1 is the textile printer, the effects are more pronounced.

The embodiments and modifications described above are mere examples of the present disclosure and the present disclosure is not limited thereto. For example, the embodiments and the modifications can be combined as appropriate.

The present disclosure includes configurations that are substantially the same as the configurations described in the embodiments, for example, configurations that are the same in function, method, and result or the same in purpose and effect. Moreover, the present disclosure encompasses configurations obtained by replacing non-essential portions of the configurations described in the embodiments. In addition, the present disclosure encompasses configurations that achieve the same effects or accomplish the same purpose as the configurations described in the embodiments. In addition, the present disclosure encompasses configurations obtained by adding known techniques to the configurations described in the embodiments.

The following can be derived from the embodiment and modifications described above.

A liquid ejecting apparatus includes:

a housing;

an ejector arranged in the housing and configured to eject a liquid;

a power supply circuit arranged in the housing and configured to supply power to the ejector; and

a partition arranged so as to separate an ejector region where the ejector is arranged and a power supply circuit region where the power supply circuit is arranged, in which

the power supply circuit includes a capacitor and a transformer,

no fan is arranged in the power supply circuit region, and

the liquid contains a polysaccharide.

According to the liquid ejecting apparatus, since no fan is disposed in the power supply circuit region, the polysaccharide is less likely to adhere to the fan, making it possible to reduce maintenance frequency and to maintain high productivity.

In the above liquid ejecting apparatus, in the housing, the power supply circuit region is separated from other regions by a power supply box, and the partition forms one surface of the power supply box.

According to the liquid ejecting apparatus, it is possible to further suppress adhesion of the polysaccharide to the power supply circuit region.

In the above liquid ejecting apparatus, the capacitor has a sleeve made of polyolefin.

According to the liquid ejecting apparatus, characteristics of the capacitor are less likely to deteriorate, making it possible to further improve reliability of the apparatus.

In the above liquid ejecting apparatus, the capacitor contains an electrolytic solution, and the electrolytic solution is composed mainly of ethylene glycol and contains water.

According to the liquid ejecting apparatus, an increase in internal pressure of the capacitor is suppressed and the characteristics are less likely to deteriorate, making it possible to further improve the reliability of the apparatus.

In the above liquid ejecting apparatus, the capacitor has a case made of aluminum.

According to the liquid ejecting apparatus, the characteristics of the capacitor are less likely to deteriorate, making it possible to further improve the reliability of the apparatus.

In the above liquid ejecting apparatus, the capacitor has a sealing plate in which an EPT rubber layer and a bakelite layer are laminated.

According to the liquid ejecting apparatus, the characteristics of the capacitor are less likely to deteriorate, making it possible to further improve the reliability of the apparatus.

In the above liquid ejecting apparatus, the capacitor has a terminal plated with copper and tin.

According to the liquid ejecting apparatus, the characteristics of the capacitor are good, and the reliability of the apparatus can be further improved.

In the above liquid ejecting apparatus, no fan is arranged in the housing.

According to the liquid ejecting apparatus, the polysaccharide does not adhere to the fan, making it possible to further reduce the maintenance frequency and to maintain higher productivity.

What is claimed is:

1. A liquid ejecting apparatus comprising:
a housing;
an ejector arranged in the housing and configured to eject a liquid;
a power supply circuit arranged in the housing and configured to supply power to the ejector; and
a partition arranged so as to separate an ejector region where the ejector is arranged and a power supply circuit region where the power supply circuit is arranged, wherein
the power supply circuit includes a capacitor and a transformer,
no fan is arranged in the power supply circuit region, and
the liquid contains a polysaccharide.

2. The liquid ejecting apparatus according to claim 1, wherein
in the housing, the power supply circuit region is separated from other regions by a power supply box, and
the partition forms one surface of the power supply box.

3. The liquid ejecting apparatus according to claim 1, wherein
the capacitor has a sleeve made of polyolefin.

4. The liquid ejecting apparatus according to claim 1, wherein
the capacitor contains an electrolytic solution, and
the electrolytic solution is composed mainly of ethylene glycol and contains water.

5. The liquid ejecting apparatus according to claim 1, wherein
the capacitor has a case made of aluminum.

6. The liquid ejecting apparatus according to claim 1, wherein
the capacitor has a sealing plate in which an EPT rubber layer and a bakelite layer are laminated.

7. The liquid ejecting apparatus according to claim 1, wherein
the capacitor has a terminal plated with copper and tin.

8. The liquid ejecting apparatus according to claim 1, wherein
no fan is arranged in the housing.
